(19) United States
(12) Patent Application Publication
(10) Pub. No.: US 2004/0030742 A1
(43) Pub. Date: Feb. 12, 2004

(54) System and method for communicating data using a multiple-role entity

(76) Inventor: Masayuki Kitagawa, Santa Clara, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/214,945

(22) Filed: Aug. 6, 2002

(51) Int. Cl. G06F 15/16

(52) U.S. Cl. 709/203

(57) ABSTRACT

The invention relates to a system for communicating data with at least one of an external host computer and at least one digital device. The system comprises a first entity and a second entity. The first entity is configured to operate based on received commands. The second entity is in data communication with the first entity and the at least one digital device. The second entity is configured to perform a hub or host function with respect to a selected one of the first entity and the digital device and, at the same time, to perform the hub or host function with respect to the other of the first entity and the digital device.

### BACKGROUND OF THE INVENTION

1. Field of the Invention

The invention relates to a data communication system, and particularly to a system and method for facilitating data communication between a host computer and at least one digital device.

2. Description of the Related Technology

With the advances of digital technology, a number of digital systems such as personal computers (PCs), digital cameras, printers, and cellular phones are being widely used. Under various circumstances, these systems communicate data with each other. As an example, a PC may communicate with a printer so as to print out image data that are stored in the PC. In addition, a digital camera may also communicate with the printer so that image data stored in the camera can be printed on the printer. Further, the digital camera may communicate with the PC so that data stored in the camera can be transferred to the PC in order for the data in the camera to be edited in the PC. In this way, the systems may be interconnected to each other for data transfer.

When these systems communicate with each other, one system may function as a host with respect to another system that functions as a device. The main function of the host includes sending an instruction to the device in which the instruction is performed. On the other hand, the main function of the device includes performing certain operations based on received instruction from the host.

### SUMMARY OF CERTAIN INVENTIVE ASPECTS OF THE INVENTION

One aspect of the invention comprises a system for communicating data with at least one of an external host computer and at least one digital device, the system comprising: a first entity configured to operate based on received commands; and a second entity in data communication with the first entity and the at least one digital device, the second entity being configured to perform a hub or host function with respect to a selected one of the first entity and the digital device and, at the same time, to perform the hub or host function with respect to the other of the first entity and the digital device.

Another aspect of the invention comprises a system for communicating data with at least one of an external host computer and at least one digital device, the system comprising: a first entity configured to operate based on received commands; and a second entity in data communication with the first entity and the at least one digital device, the second entity configured to perform a hub or host function with respect to one of the first entity and the digital device during a first time period, and to perform the hub or host function with respect to the other of the first entity and the digital device during a second time period that at least partially overlaps with the first time period.

Another aspect of the invention comprises a system for communicating data with at least one of an external host computer and at least one digital device, the system comprising: a device portion configured to operate based on received commands; a host portion in data communication with the device portion and the at least one digital device, the host portion being configured to perform a host function that provides a host interface with respect to a selected one of the device portion and the digital device, and at the same time, to perform the host function with respect to the other of the device portion and the digital device; and a hub portion in data communication with the external host computer, and the device portion and the digital device, the hub portion being configured to perform a hub function that provides a hub interface between the external host and a selected one of the device portion and the digital device, and at the same time to perform the hub function between the external host computer and the other one of the device portion and the digital device.

Still another aspect of the invention comprises a system for communicating data with at least one of an external host computer and at least one digital device, the system comprising: a device portion configured to operate based on received commands; a host portion in data communication with the device portion and the at least one digital device, the host portion configured to perform a host function that provides a host interface with respect to one of the device portion and the digital device during a first time period, and to perform the host function with respect to the other of the device portion and the digital device during a second time period that at least partially overlaps with the first time period; and a hub portion in data communication with the external host computer, and the device portion and the digital device, the hub portion configured to perform a hub function that provides a hub interface between the external host computer and a selected one of the device portion and the digital device in a third time period, and to perform the hub function between the external host computer and the other one of the device function and the digital device during a fourth time period that at least partially overlaps with the third time period.

Still another aspect of the invention comprises a system for communicating data with at least one of an external host computer and at least one digital device, the system comprising: a device portion configured to operate based on received commands; and a host portion in data communication with the device portion and the at least one digital device, the host portion configured to perform a host function that provides a host interface with respect to one of the device portion and the digital device, and at the same time, to perform the host function with respect to the other of the device portion and the digital device.

Still another aspect of the invention comprises a method of communicating data in a system having at least one of an external host computer and at least one digital device, the method comprising: providing a first entity and a second entity, the first entity configured to operate based on received commands; connecting the second entity to the first entity and the at least one digital device; and allowing the second entity to perform a host or hub function with respect to one of the first entity and the digital device while the second entity performs the host or hub function with respect to the other of the first entity and the digital device.

Yet another aspect of the invention comprises a method of communicating data in a system having a multiple-role entity, and at least one of a host computer and a digital device, the method comprising: communicating data between a device portion and another functional portion within the multiple-role entity; communicating data between the other functional portion and an external interface; and selecting the other functional portion to communicate with the digital device or the host computer via the external interface.

Further another aspect of the invention comprises a method of communicating data in a system having at least one of a host computer and a digital device, the method comprising: providing a device portion, a host portion and a hub portion, the device portion being configured to operate based on received commands, the host portion being configured to perform a host function that provides a host interface, and the hub portion being configured to perform a hub function that provides a hub interface; generating first and second mode signals; allowing the host portion to perform the host function with respect to one of the device portion and the digital device while the host portion performs the host function with respect to the other of the device portion and the digital device based on the first mode signal; and allowing the hub portion to perform the hub function between the host computer and one of the device portion and the digital device while the hub portion performs the hub function between the host computer and the other of the device portion and the digital device based on the second mode signal.

### BRIEF DESCRIPTION OF THE DRAWINGS

The foregoing and other features of the invention will become more fully apparent from the following description and appended claims taken in conjunction with the following drawings, in which like reference numerals indicate identical or functionally similar elements.

FIG. 1 illustrates a typical communication system including a host and a device that are connected to each other via an interface.

FIG. 2 illustrates another typical communication system including a host and a plurality of devices that are connected to each other via a hub.

FIG. 3 illustrates another typical communication system including a host and two devices that are connected to each other via an entity including a hub portion and two device portions.

FIGS. 4a and 4b illustrate another typical communication system including a two role entity and a host or device.

FIG. 5 illustrates a communication system according to one embodiment of the invention.

FIG. 6 illustrates a communication system according to another embodiment of the invention.

FIG. 7 illustrates a communication system according to further embodiment of the invention.

FIG. 8 illustrates an exemplary block diagram of the multiple-role entity shown in FIGS. 5-7, in one embodiment.

FIG. 9 illustrates a schematic diagram of the external host connection detector shown in FIG. 8.

FIG. 10 illustrates a schematic diagram of the reset circuit shown in FIG. 8.

FIG. 11 illustrates an example structure of the hub portion shown in FIG. 8.

FIG. 12 illustrates an example structure of the device portion shown in FIG. 8.

FIG. 13 illustrates an example structure of the host portion shown in FIG. 8.

FIG. 14 illustrates an example structure of the switch shown in FIG. 8.

### DETAILED DESCRIPTION OF THE CERTAIN EMBODIMENTS OF THE INVENTION

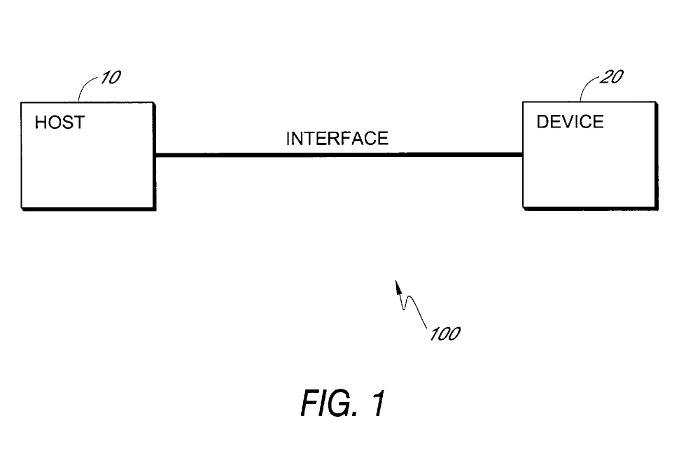

FIG. 1 illustrates a typical communication system 100 including a host 10 and a device 20. The host 10 and the device 20 are connected to each other via an interface. The connection may be made to carry out high-speed or low-speed data transfer. In one embodiment, for example, the host 10 may be a PC, and the device 20 may be, for example, one of a digital camera, a cellular phone, a printer, or a digital audio player. The interface may be, for example, a USB (Universal Serial Bus). Other embodiments may use other devices and interfaces.

In FIG. 1, the host 10 performs only a host function, which allows the host 10 to send instructions to the device 20, and to communicate with the device 20 by sending data to and receiving data from the device 20. The device 20, on the other hand, performs only a device function, which allows the device 20 to perform operations based on the instructions received from the host 10, and to communicate with the host 10 by sending data to and receiving data from the host 10. Thus, the system shown in FIG. 1 lacks versatility, since the host 10 cannot be used as a device and the device 20 cannot be used as a host, either.

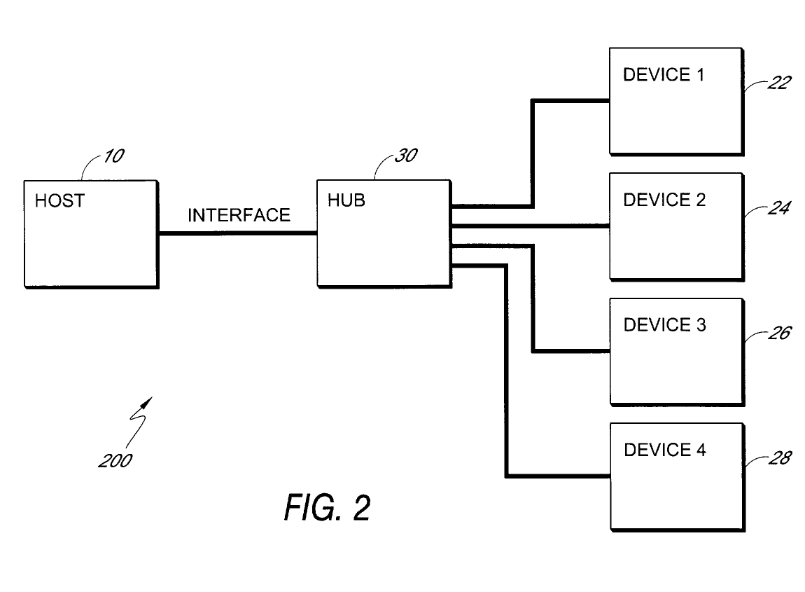

FIG. 2 illustrates another typical communication system 200 including a host 10 and a plurality of devices 22-28. The host 10 and the device 22-28 are connected to each other via a hub 30. Generally, a hub is a device that provides a connection between at least one computing device and a plurality of computing devices. In FIG. 2, the host 10 communicates with each of the devices 22-28 via the hub 30.

Specifically, the host 10 is connected to the hub 30 via an interface, the devices 22-28 are connected to ports (not shown) of the hub 30. The host 10 performs only a host function, which allows the host 10 to send instructions to each of the devices 22-28, and to communicate with the devices 22-28 by sending data to and receiving data from the devices 22-28, through the hub 30. The devices 22-28, on the other hand, perform only a device function, which allows the devices 22-28 to perform operations based on the instructions received from the host 10, and to communicate with the host 10 by sending data to and receiving data from the host 10, through the hub 30. In addition, the hub 30 performs only as a hub as shown in FIG. 2. Thus, the system shown in FIG. 2 also lacks versatility, because each element performs only its own function.

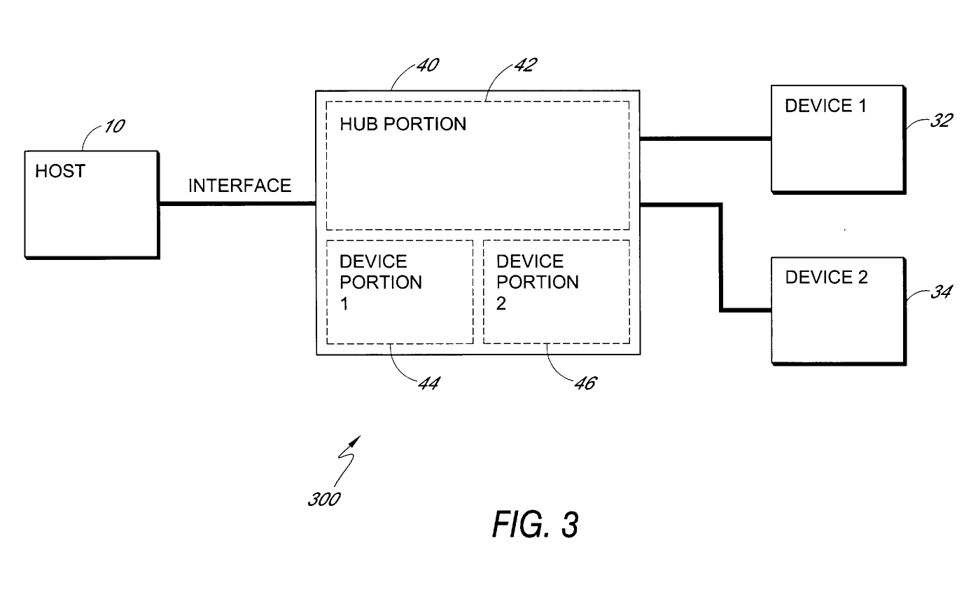

FIG. 3 illustrates another typical communication system 300 including a host 10 and devices 32 and 34. The host 10 and the devices 32 and 34 are connected to each other via an entity 40. The entity 40 comprises a hub portion 42, and two device portions 44 and 46. The hub portion 42 functions as a hub between the host 10 and the devices 32 and 34. The hub portion 42 also functions as a hub between the host 10 and the device portions 44 and 46 of the entity 40. In this way, the host 10 communicates with the devices 32 and 34 through the hub portion 42 of the entity 40. The host 10 also communicates with the device portions 44 and 46 through the hub portion 42. Thus, the entity 40, as a whole, functions as a device with respect to the host 10, and functions as a hub between the host 10 and the devices 32 and 34. However, the entity 40 cannot allow the host 10 to communicate with the device portions 44 and 46 while the host 10 is communicating with the devices 32 and 34 through the hub portion 42. Furthermore, the entity 40 cannot allow the host 10 to communicate with the devices 32 and 34 through the hub portion 42 while the host 10 is communicating the device portions 44 and 46. In other words, the entity 40 can perform only one function at a time.

In one embodiments, it is assumed that the host 10 is a PC, the device 32 is a printer, and the entity 40 is a digital camera. In addition, the device portion 44 is assumed to be a memory of the digital camera. Then, the PC 10 may send the digital camera 40 a command that instructs the camera 40 to store transferred image data from the PC 10 in the memory 44. The digital camera 40 may store the image data in the memory 44 based on the command. On the other hand, the PC 10 may send the printer 32 a command that instructs the printer 32 to print out image data that is transferred from the PC 10. The printer 32 may print out the transferred image data based on the command. However, in the system of FIG. 3, sending the camera 40 a command to store the image in the memory 44 and sending the printer 32 a command to print the data through the hub portion 42 cannot be performed at the same time. That is, since the digital camera 40 performs each function one at a time, the hub portion 42 of the digital camera 40 cannot allow the PC 10 to communicate with the memory 44 while the PC 10 is communicating with the printer 32. In addition, the hub portion 42 of the digital camera 40 cannot allow the PC 10 to communicate with the printer 32 while the PC 10 is communicating with the memory 44. Therefore, the system shown in FIG. 3 also lacks versatility.

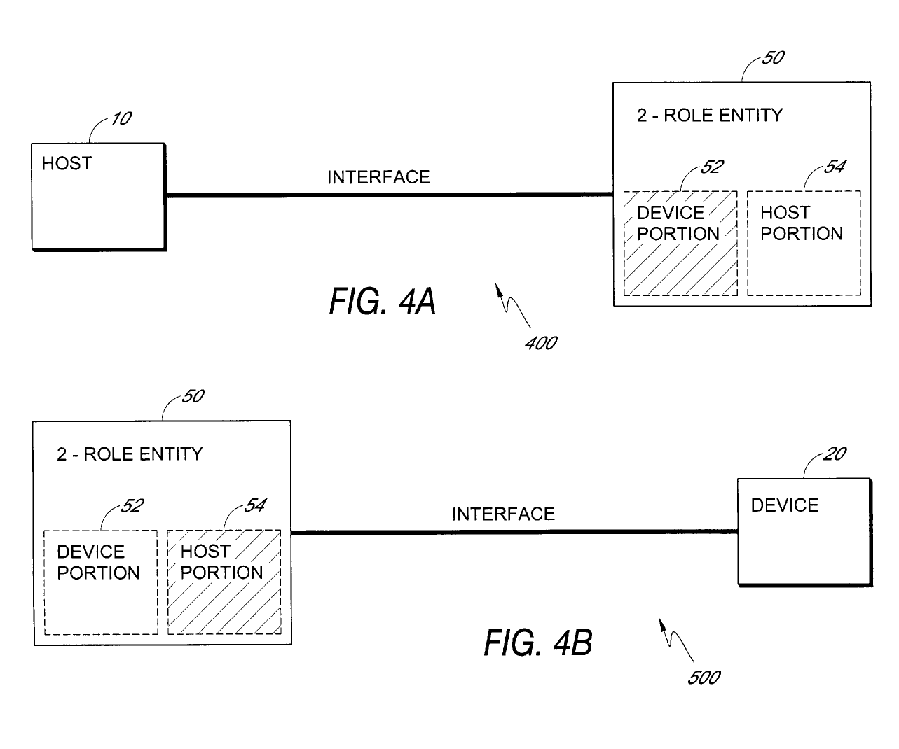

FIGS. 4a and 4b illustrate other typical communication system configurations 400 and 500 including a two role entity 50 and a host 10 or device 20. The 2-role entity 50 includes a device portion 52 and a host portion 54. In FIG. 4a, the host 10 communicates with the device portion 52 of the 2-role entity 50. As shown in FIG. 4a, when the entity 50 communicates with the host 10, even if the 2-role entity 50 includes a device portion 52 and a host portion 54, the entity 50 (device portion 52) functions only as a device with respect to the host 10. In FIG. 4b, the device 20 communicates with the host portion 54 of the 2-role entity 50. As shown in FIG. 4b, when the entity 50 communicates with the device 20, the entity 50 (host portion 54) functions only as a host with respect to the device 20. The system shown in FIGS. 4a and 4b is disclosed in U.S. patent application Ser. (No. 09/757314) filed on Jan. 9, 2001 by the same inventor, and is incorporated by reference.

The system illustrated in FIGS. 4a and 4b has the 2-role entity 50, but the entity 50 performs only one function at a time. The 2-role entity 50 cannot perform the device function with respect to the host 10 as shown in FIG. 4a at the same time that the entity 50 is performing the host function with respect to the device 20 as shown in FIG. 4b. In addition, the 2-role entity 50 cannot perform the host function with respect to the device 20 shown in FIG. 4b while the entity 50 is performing the device function with respect to the host 10 as shown in FIG. 4a. Thus, in order to convert one function (e.g. host function) of the entity 50 to the other (e.g. device function) in the system, a reset operation has to be applied to the system. Therefore, the system does not have the versatility or convenience offered by the present invention.

Thus, one aspect of the invention is to provide a multiple-role entity that has versatility in data communication between an external host computer and at least one digital device.

According to one feature of the invention, there is a multiple-role entity comprising a hub portion, a host portion and a device portion. The multiple-role entity can work standalone without communicating with an external host computer or any external digital device. The host portion may function as a host with respect to the device portion located within the entity.

According to another feature of the invention, there is a multiple-role entity comprising a host portion and a device portion. The multiple-role entity may communicate with at least one digital device. The host portion can function as a host with respect to at least one digital device while the host portion is functioning as a host with respect to the device portion.

According to still another feature of the invention, there is a multiple-role entity comprising a hub portion and a device portion. The multiple-role entity may communicate with an external host computer and at least one digital device. The multiple-role entity functions as a hub between the external host computer and the device portion while the entity is functioning as a hub between the external host computer and the at least one device.

According to yet another feature of the invention, there is a multiple-role entity comprising a hub portion, a host portion and a device portion. The multiple-role entity may communicate with an external host computer and at least one digital device. First, the host portion of the multiple-role entity may function as a host with respect to the device portion and the at least one device. When the external host computer is connected to the multiple-role entity, the entity disconnects the connection between the host portion, the device portion, and the at least one device. After that, the entity establishes a connection between the hub portion, and the device portion and the at least one device. The entity starts functioning as a hub between the external host computer, the device portion, and the at least one device. Second, the hub portion of the multiple-role entity may function as a hub between the external host computer, the device portion, and the at least one device. When the external host computer is disconnected from the multiple-role entity, the entity disconnects the connection between the hub portion, the device portion, and the at least one device. After that, the entity establishes a connection between the host portion, the device portion, and the at least one device. Afterwards, the entity starts functioning as a host with respect to the device portion and the at least one device.

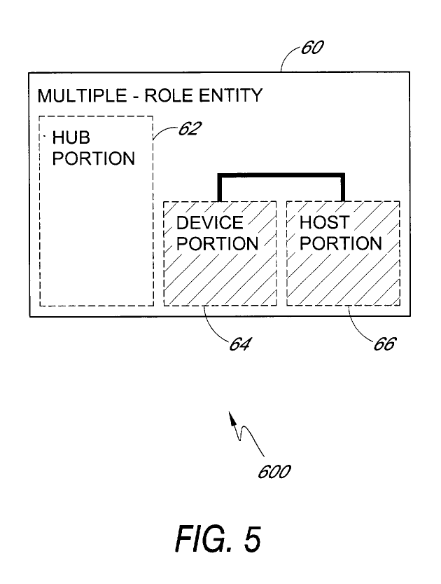

FIG. 5 illustrates a communication system 600 according to one embodiment of the invention. The multiple-role entity 60 comprises a hub portion 62, a device portion 64, and a host portion 66. The device and host portions 64 and 66 are in data communication with each other. Though the connection between the hub portion 62 and the device portion 64 is not shown, the portions 62 and 64 may be in data communication with each other, if necessary. The multiple-role entity 60 can work standalone without communicating with a host computer or a device (not shown). That is, in this embodiment the host portion 66 may communicate with only the device portion 64 within the entity 60.

In one embodiment, the multiple-role entity 60 may be embedded into, for example, a digital camera (not shown). A microprocessor of the digital camera 60 may be selected as the host portion 66. In addition, a memory of the digital camera 60 may be selected as the device portion 64. In this case, the microprocessor (host portion 66) may send an instruction with respect to storing image data in the memory (device portion 64). The memory 64 of the digital camera 60 may store the image in response to the received instruction from the microprocessor (host portion 66).

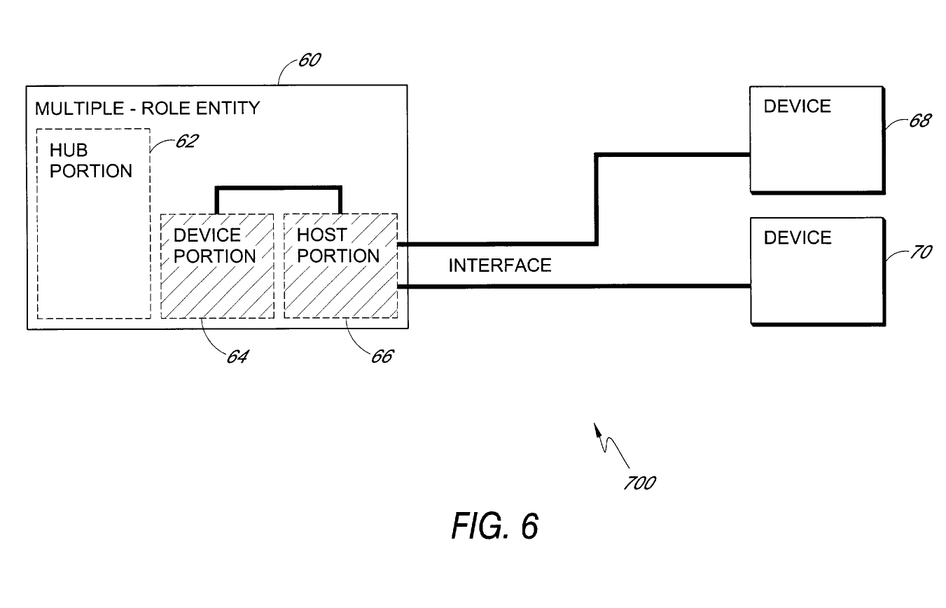

FIG. 6 illustrates a communication system 700 according to another embodiment of the invention. The system 700 comprises a multiple-role entity 60 and devices 68 and 70. The multiple-role entity 60 comprises a hub portion 62, a device portion 64 and a host portion 66. The device portion 64 and the host portion 66 are in data communication with each other. The host portion 66 functions as a host with respect to at least one of the devices 68 and 70. In addition, the host portion 66 functions as a host with respect to the device portion 64 within the multiple-role entity 60. It is noted that the host portion 66 functions as a host with respect to at least one of the devices 68 and 70, while the host portion 66 is still functioning as a host with respect to the device portion 64 in the multiple-role entity 60. It is also noted that the host portion 66 functions as a host with respect to the device portion 64, while the host portion 66 is still functioning as a host with respect to the at least one of the devices 68 and 70 via an interface.

In one embodiment, the multiple-role entity 60 in FIG. 6 may be implemented inside, for instance, a digital camera (not shown). The devices 68 and 70 may be, for instance, a cellular phone and a printer, respectively. The host portion 66 may include, for example a microprocessor that controls the operation of the digital camera 60. The device portion 64 may include, for example, a memory that is controlled by the microprocessor. In this situation, the microprocessor (host portion 66) may send the printer (device 70) an instruction that instructs the printer 70 to print out an image stored therein, and after that may communicate with the printer 70 as a host. At the same time as sending the instruction to the printer 70 or while communicating with the printer 70, the microprocessor 66 may send an instruction to the memory (device portion 64) with respect to storing an image in the memory 64, and communicate with the memory 64 as a host. That is, the microprocessor 66 performs a host function with respect to one of the memory 64 and the printer 70 while, at the same time, the microprocessor 66 performs a host function with respect to the other of the memory 64 and the printer 70. This means that the microprocessor 66 performs a host function with respect to one of the memory 64 and the printer 70 in a first time period, and performs a host function with respect to the other of the memory 64 and the printer 70 in a second time period that at least partially overlaps with the first time period. It is noted that the microprocessor 66 may also send an instruction to the cellular phone 68 about displaying an image stored in the cellular phone 68, while the microprocessor 66 is performing a host function with respect to the memory 64.

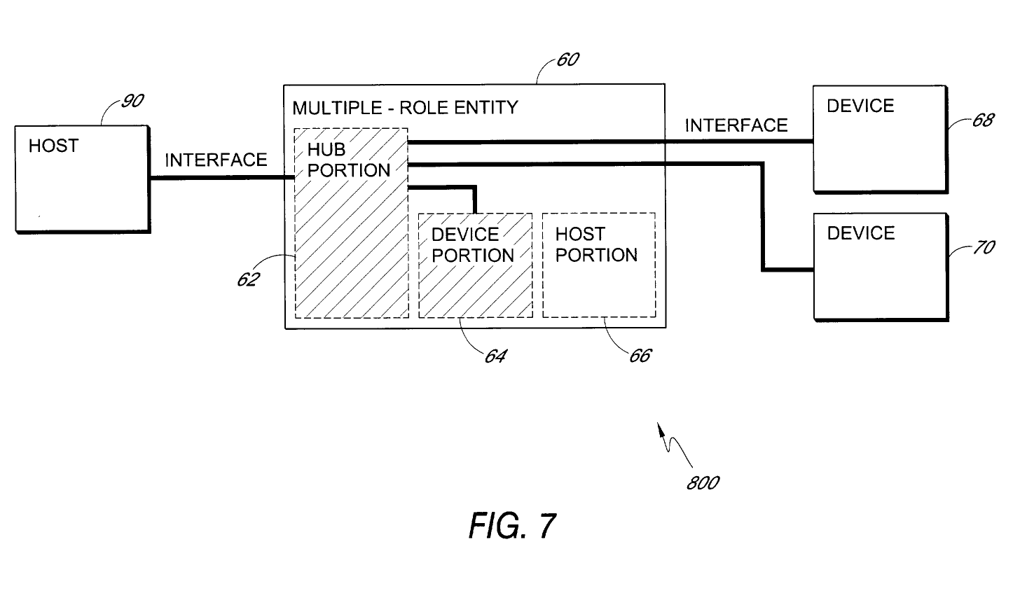

FIG. 7 illustrates a communication system 800 according to a further embodiment of the invention. The system 800 comprises a multiple-role entity 60, an external host 90, and devices 68 and 70. The multiple-role entity 60 comprises a hub portion 62, a device portion 64 and a host portion 66. The hub portion 62 and the device portion 64 are in communication with each other. The hub portion 62 functions as a hub between the external host 90 and the device portion 64. In addition, the hub portion 62 functions as a hub between the external host 90 and at least one of the devices 68 and 70. It is noted that the hub portion 62 performs a hub function between the external host 90 and the device portion 64 while, at the same time, the hub portion 62 is still functioning as a hub between the external host 90 and at least one of the devices 68 and 70. It is also noted that the hub portion 62 performs a hub function between the external host 90 and at least one of the devices 68 and 70 while, at the same time, the hub portion 62 is still functioning as a hub between the external host 90 and the device portion 64. This means that the hub portion 62 performs a hub function between the external host 90 and the device portion 64 in a first time period, and performs a hub function between the external host 90 and the devices 68 and 70 in a second time period that at least partially overlaps with the first time period.

In one embodiment, the external host 90 may include, for instance, a PC. The devices 68 and 70 may include, for instance, a cellular phone and a printer, respectively. The multiple-role entity 60 in FIG. 7 may include, for instance, a digital camera (not shown). In this case, the host portion 66 may include, for example, a microprocessor that controls the operation of the digital camera 60. The device portion 64 may include, for example, a memory that is controlled by the microprocessor 66. In this situation, the PC 90 may send an instruction to the printer 70 through the hub portion 62. Then, the hub portion 62 allows data communication between the PC 90 and at least one of the cellular phone 68 and the printer 70. In addition, the PC 90 may send an instruction to the memory 70 through the hub portion 62. Then, the hub portion 62 allows data communication between the PC 90 and the memory 64.

It is appreciated that the hub portion 62 functions as a hub between the PC 90 and the memory 64 while the hub portion 62 is performing as a hub between the PC 90 and at least one of the cellular phone 68 and the printer 70. It is also noted that the hub portion 62 performs a hub function between the PC 90 and at least one of the cellular phone 68 and the printer 70 while the hub portion 62 is still functioning as a hub between the PC 90 and the memory 64.

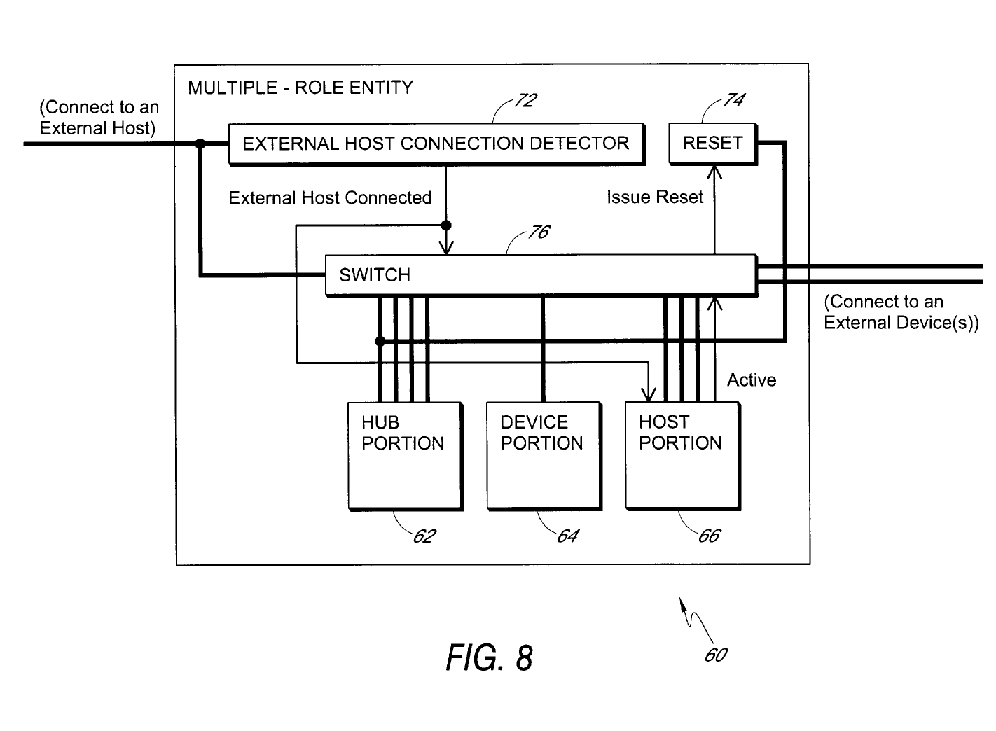

FIG. 8 illustrates an exemplary block diagram of the multiple-role entity 60 shown in FIGS. 5-7, in one embodiment. The multiple-role entity 60 includes an external host connection detector 72, a reset circuit 74, a switch 76 in addition to the hub, device, and host portions 62-66. The hub portion 62 may allow the external host 90 to communicate with the device portion 64 and the external devices 68 and 70 through the switch 76 (FIG. 7). The host portion 66 may communicate with the device portion 64 and the external devices 68 and 70 through the switch 76 (FIG. 6). The external host connection detector 72 detects whether the host 90 is connected to the multiple-role entity 60. If the external host 90 is connected to the multiple-role entity 60, the host connection detector 72 outputs a detection signal which is provided to the switch 76 and the host portion 66. In one embodiment, the detection signal may be a logic high signal if the external host 90 is connected to the multiple-role entity 60, while it may be a logic low signal if the external host 90 is not connected to the multiple-role entity 60.

When the switch 76 receives a logic high signal from the host connection detector 72, which means that the host 90 is connected to the entity 60, the switch 76 allows data communication between the external host 90 (shown in FIG. 7) and the device portion 64 through the hub portion 62. In addition, the switch 76 allows data communication between the external host 90 and at least one of the devices 68 and 70 through the hub portion 62. In that situation, the multiple-role entity 60 is connected to the external host 90 and the devices 68 and 70 as shown in FIG. 7. It is noted that the switch 76 allows the external host 90 to function as a host with respect to the device portion 64 while the host 90 is performing a host function with respect to the at least one of the devices 68 and 70. It is also noted that the switch 76 allows the external host 90 to function as a host with respect to the at least one of the devices 68 and 70 while the host 90 is performing a host function with respect to the device portion 64. After the external host 90, and the device portion 64 and the devices 68 and 70 are connected to each other and before data communication is performed therebetween, a reset signal which has been issued from the switch 76 may be provided to the device portion 64 and the devices 68 and 70 via the reset circuit 74 and the hub portion 62. Thus, the hub and device portions 62 and 64, and the devices 68 and 70 become ready to communicate with the external host 90.

When the switch 76 receives, a logic low signal, for example, from the host connection detector 72, the switch 76 allows data communication between the host portion 66 and the device portion 64. In addition, the switch 76 allows data communication between the host portion 66 and at least one of the devices 68 and 70 through the interface. In this situation, the multiple-role entity 60 is connected to the devices 68 and 70 as shown in FIG. 6. It is noted that the switch 76 allows the host portion 66 to function as a host with respect to the device portion 64 while the host portion 66 is performing a host function with respect to the at least one of the devices 68 and 70. It is also noted that the switch 76.allows the host portion 66 to function as a host with respect to the at least one of the devices 68 and 70 while the host portion 66 is performing a host function with respect to the device portion 64. After the host portion 66 and the device portion 64 and the devices 68 and 70 are connected to each other and before data communication is performed therebetween, a reset signal may be provided to the device portion 64 and the devices 68 and 70. Thus, the device portion 64 and the devices 68 and 70 become ready to communicate with the host portion 66.

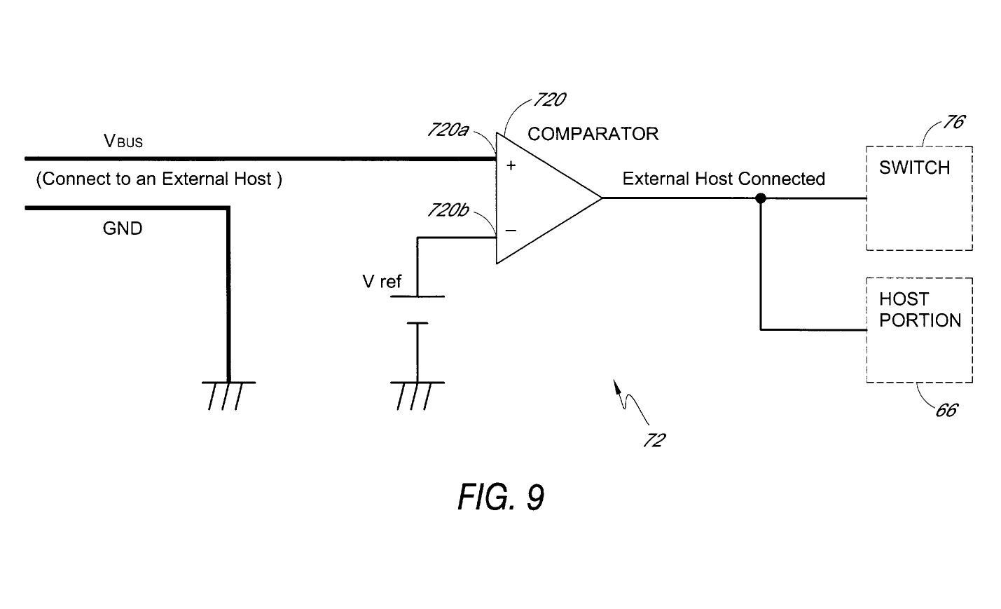

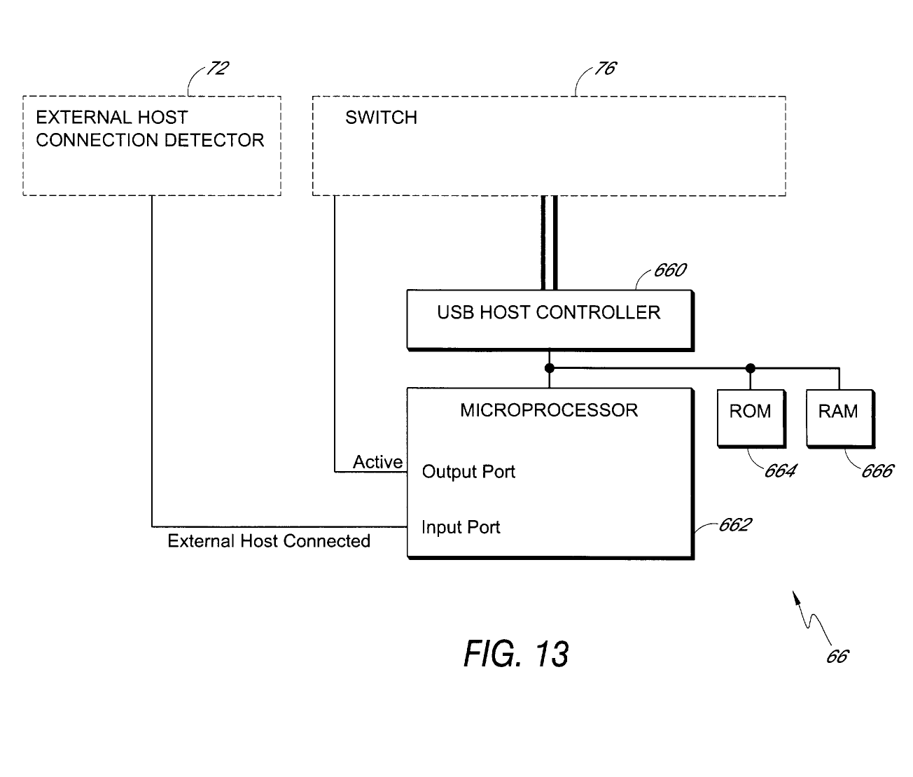

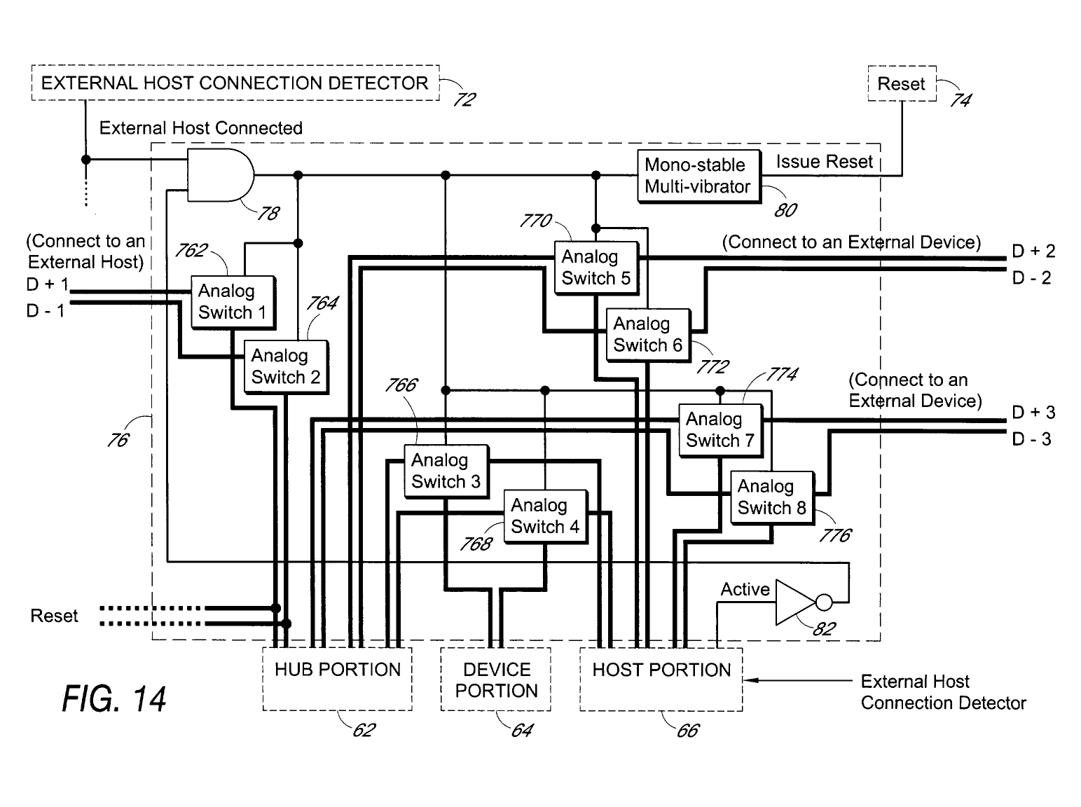

FIG. 9 illustrates a schematic diagram of one embodiment of the external host connection detector 72 shown in FIG. 8. The host connection detector 72 comprises a comparator 720 that has positive and negative input terminals 720a and 720b. The positive terminal 720a of the comparator 720 is connected to V_{BUS} which is greater than Vref that is connected to the negative input terminal 720b, or the positive terminal 720a is connected to V_{GND} that is smaller than Vref (this latter configuration not shown in FIG. 9). If the external host 90 (shown in FIG. 7) is connected to the entity 60, V_{BUS} may be provided to the positive input terminal 720a. In contrast, if the host 90 is not connected to the entity 60, V_{GND} may be provided to the positive input terminal 720a. Thus, if the host 90 is connected to the entity 60, the comparator 720 outputs V_{BUS} to the switch 76 (AND gate 78; FIG. 14) and the host portion 66 (microprocessor 662; FIG. 13), otherwise the comparator 720 outputs V_{ref} to the AND gate 78 and the microprocessor 662. The comparator 720 may be, for example, TLV2702, operational amplifier and push-pull comparator available from Texas Instruments.

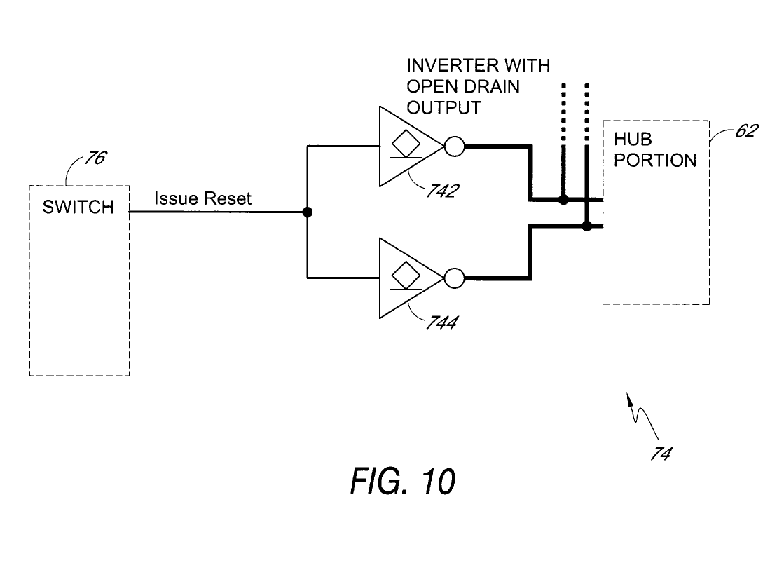

FIG. 10 illustrates a schematic diagram of one embodiment of the reset circuit 74 shown in FIG. 8. The reset circuit 74 comprises first and second inverters with open drain output 742 and 744. The inverters 742 and 744 invert a reset signal that has been fed from the switch 76, and provide the inverted signals to the hub portion 62. Detailed operation with respect to the reset circuit 74 will be described later by referring to FIG. 14. The inverters 742 and 744 with open-drain output may be, for example,. SN74LVC1G06, single inverter buffer with open-drain output, available from Texas Instruments.

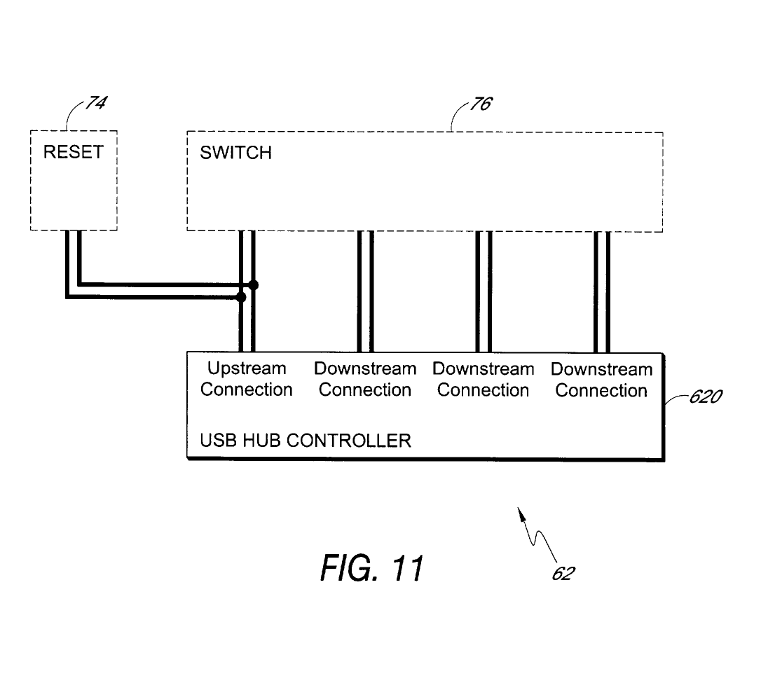

FIG. 11 illustrates an exemplary block diagram of one embodiment of the hub portion 62 shown in FIG. 8. In this embodiment, the hub portion 62 comprises a USB hub controller 620. The USB hub controller 620 comprises one upstream connection port and three downstream connection ports (not shown). The upstream connection port is connected to the external host 90 and the reset circuit 74 through the switch 76 (FIGS. 8 and 14). The downstream connection ports are connected to the external devices 68 and 70, the device portion 64, and the host portion 66 through the switch 76 (FIGS. 8 and 14). The upstream connection is provided from at least one of the device portion 64 and the devices 68 and 70 to the external host 90. The downstream connection is provided from the external host 90 to at least one of the device portion 64 and the devices 68 and 70. The USB hub controller 620 may be, for example, USB 2.0 Hub controller, uPD720110 available from NEC.

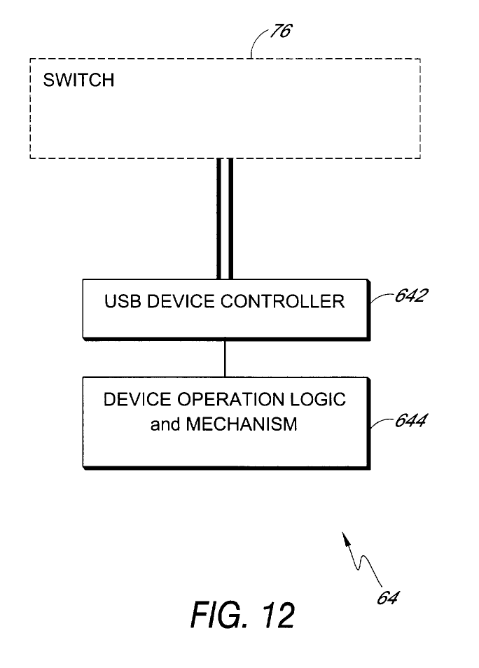

FIG. 12 illustrates an exemplary block diagram of one embodiment of the device portion 64 shown in FIG. 8. In this embodiment, the device portion 64 comprises a USB device controller 642 and a device operation logic and mechanism 644. The USB device controller 642 is connected to the switch 76 and the device operation logic and mechanism 644. The USB device controller 642 may be, for example, USB-ATAPI Single Chip, ISD-200 available from In-System Design Inc., or USB 2.0 Peripheral Controller, NET2290 available from Net Chip Technology Inc. The device operation logic and mechanism 644 may be, for example, CD-RW Drive, CR-4805 available from Mitsumi Co. Ltd., or a Digital Camera.

FIG. 13 illustrates an exemplary block diagram of one embodiment of the host portion 66 shown in FIG. 8. The host portion 66 comprises a USB host controller 660 and a microprocessor 662, a ROM 664, and a RAM 666. The USB host controller 660 is connected to the switch 76 and the microprocessor 662. The microprocessor 662 is connected to the switch 76 via an output port, and the external host 90 via an input port. The ROM 664 and RAM 666 are connected to each other, and connected between the USB host controller 660 and the microprocessor 662. The USB host controller 660 may be, for example, USB 2.0 Host Controller, uPD720100 available from NEC. The microprocessor 662 may be, for example, RISC Processor, SH88-0 available from Hitachi. The ROM 664 may be, for example, Flash Memory, HB29W2561ST available from Hitachi. The RAM 666 may be, for example, SRAM, uPD431000A available from NEC, or SDRAM, HM5225645FBP available from Hitachi.

FIG. 14 illustrates an exemplary detailed block diagram of one embodiment of the switch 76 shown in FIG. 8. The switch 76 comprises analog switches 1-8 (762-776), an AND gate 78, a mono-stable multi-vibrator 80, and an inverter 82. The inverter 82 is connected between the host portion 66 and the AND gate 78, and negates an active signal or a non-active signal output from the host portion 66 and provides the negated signal to the AND gate 78. The AND gate 78 is connected to the external host connection detector 72 and the output of the inverter 82 via the input terminals thereof, respectively. The AND gate 78 is connected to the analog switches 1-8 and the mono-stable multi-vibrator 80 via the output terminal thereof. The AND gate 78 performs logic AND gate operation, and outputs the operation result to all of the analog switches 762-776 and the mono-stable multi-vibrator 80. The operation result is used for controlling switching operation of the switches 762-776.

The analog switches 762 and 764 perform switching between the external host 90 (FIG. 7) connected to the USB lines (D+1, D−1) and the hub portion 62 based on the output of the AND gate 78. In one embodiment of the invention, the analog switches 762 and 764 may connect the hub portion 62 and the USB lines D+1 and D−1 based on a logic high signal output from the AND gate 78. In contrast, the analog switches 762 and 764 may disconnect the hub portion 62 from the USB lines D+1 and D−1 based on a logic low signal output from the AND gate 78. In another embodiment of the invention, the switches 762 and 764 can be implemented such that they connect the USB lines and the hub portion 62 based on a logic low signal while they disconnect the USB lines from the hub portion 62 based on a logic high signal.

The analog switches 766 and 768 may perform switching between the device portion 64 and one of the hub portion 62 and host portion 66 on the basis of the output of the AND gate 78. In one embodiment of the invention, the analog switches 766 and 768 may connect the device portion 64 and the host portion 66 on the USB lines based on a logic high signal while keeping the hub portion 62 and the device portion 64 disconnected. The analog switches 766 and 768 may also connect the device portion 64 and the hub portion 62 on the USB lines based on a logic low signal while keeping the host portion 66 and the device portion 64 disconnected. In another embodiment of the invention, the switches 766 and 768 can be implemented such that they connect the device portion 64 and the host portion 66 based on a logic low signal while they connect the device portion 64 and the hub portion 62 based on a logic high signal.

The analog switches 770 and 772 perform switching between one external device 68 (FIG. 7) connected to the USB lines (D+2, D−2) and one of the hub portion 62 and the host portion 66 based on the output of the AND gate 78. In one embodiment of the invention, the analog switches 770 and 772 may connect the USB lines D+2 and D−2 that are connected to the external device 68, respectively, to the hub portion 62 based on a logic low signal that is output from the AND gate 78, while keeping the USB lines D+2 and D−2 and the host portion 66 disconnected. In contrast, the analog switches 770 and 772 may connect the USB lines D+2 and D−2, respectively, to the host portion 66 based on a logic high signal output from the AND gate 78, while keeping the USB lines D+2 and D−2, and the hub portion 62 disconnected. In another embodiment of the invention, the switches 770 and 772 can be implemented such that they connect the external device 68 and the hub portion 62 based on a logic high signal, while they connect the USB lines (D+2, D−2) and the host portion 66 based on a logic low signal.

The analog switches 774 and 776 perform switching between another external device 70 (FIG. 7) connected to the USB lines (D+3, D−3) and one of the hub portion 62 and the host portion 66 based on the output of the AND gate 78. In one embodiment of the invention, the analog switches 774 and 776 may connect the USB lines D+3 and D−3 that are connected to the external device 70, respectively, to the hub portion 62 based on a logic high signal output from the AND gate 78, while keeping the USB lines (D+3, D−3) and the host portion 66 disconnected. In contrast, the analog switches 774 and 776 may also connect the USB lines D+3 and D−3, respectively, to the host portion 66 based on a logic low signal output from the AND gate 78, while keeping the USB lines (D+3 and D−3) and the hub portion 62 disconnected. In another embodiment of the invention, the switches 774 and 776 can be implemented such that they connect the external device 70 and the hub portion 62 based on a logic low signal, while they connect the USB lines (D+3, D−3) and the host portion 66 based on a logic high signal.

Each of the analog switches 762-776 discussed above may be, for example, TL601, P-MOS Analog Switch, available from Texas Instruments.

The mono-stable multi-vibrator 80 outputs a pulse signal based on the output of the AND gate 78, for example a logic low signal. The pulse signal is provided to the reset circuit 74. The pulse signal allows the reset circuit 74 to issue a reset signal that is provided to the hub portion 62. The mono-stable multi-vibrator 80 may be, for example, SN74LV221A, Dual Mono-stable Multi-vibrators available from Texas Instruments.

Now, the whole operation of the multiple-role entity 60 will be explained by referring to FIGS. 9-14. For the convenience, the embodiments shown in FIGS. 6 and 7 will be referred to Modes I and II hereinafter, respectively.

### Operation of MODE I

When power is turned on and the host portion 66 becomes ready for operation, the microprocessor 662 of the host portion 66 (FIG. 13) monitors the signal fed from the external host connection detector 72. Since in Mode I the external host 90 is not connected to the entity 60, the input terminal 720a of the comparator 720 is almost 0V (FIG. 9). Vref is set to, for example, 3.0V to provide reference voltage for the input terminal 720b of the comparator 720. As the result of comparing the inputs 720a and 720b, the comparator 720 outputs a logic low signal to one input terminal of the AND gate 78 in the switch 76 (FIGS. 9 and 14) and to the input port of the microprocessor 662 of the host portion 66 (FIGS. 9 and 13). In response to the logic low signal into the input port, the microprocessor 662 generates an active signal which is regarded as a logic high signal and provides it to the inverter 82.

The inverter 82 negates the active signal and outputs a non-active signal that is regarded as a logic low signal. The non-active signal (a logic low signal) is provided to the other input terminal of the AND gate 78. Since one logic high signal (V_{ref}) and one logic low signal (non-active signal) are provided to the input terminals of the AND gate 78, respectively, the AND gate 78 outputs a logic low signal. The logic low signal is provided to all of the analog switches 762-776.

The logic low signal allows the analog switches 762 and 764 to disconnect the USB lines D+1 and D−1 that are connected to the external host 90 from the hub portion 62. The hub, device, and host portions 62-66 are connected to the analog switches 762-776 through USB lines shown as bold lines in FIG. 14. The logic low signal also allows the analog switches 766 and 768 to connect the device portion 64 and the host portion 66. Specifically, the USB device controller 642 (FIG. 12) of the device portion 64 is connected to the USB host controller 660 (FIG. 13) of the host portion 66 through the USB lines. In addition, the logic low signal allows the analog switches 770 and 772 to connect the external device 68 (FIG. 6) that is connected to the USB lines D+2 and D−2 to the host portion 66. Specifically, the USB lines D+2 and D−2 are connected to the USB host controller 660 (FIG. 13) of the host portion 66 through the USB lines. Furthermore, the logic low signal allows the analog switches 774 and 776 to connect the external device 70 (FIG. 6) that is connected to the USB lines D+3 and D−3 to the host portion 66. Specifically, the USB lines D+3 and D−3 are connected to the USB host controller 660 (FIG. 13) of the host portion 66 through the USB lines.

The microprocessor 662 of the host portion 66 instructs the USB host controller 660 to issue a USB reset signal in order to start procedures specified in the USB specification on all of the USB lines that are connected between the host portion 66, and the device portion 64 and the external devices 68 and 70. Thus, the device portion 64 and the external devices 68 and 70 become ready to work with the host portion 66. After that, the host portion 66 of the multiple-role entity 60 performs a host function with respect to at least one of the external devices 68 and 70 while the host portion 66 functions as a host with respect to the device portion 64 in the entity 60.

### Operation of MODE II

When power is turned on and the host portion 66 becomes ready for operation, the microprocessor 662 of the host portion 66 (FIG. 13) monitors the signal fed from the external host connection detector 72.

Since in Mode II the external host 90 is connected to the entity 60, the input terminal 720a of the comparator 720 may be, for example, 4.0V or higher. Vref is set to, for example, 3.0V to provide reference voltage for the input terminal 720b of the comparator 720. As the result of comparing the inputs 720a and 720b, the comparator 720 outputs a logic high signal to the one input terminal of the AND gate 78 of the switch 76 (FIGS. 9 and 14) and to the microprocessor 662 of the host portion 66 (FIGS. 9 and 13).

In response to the logic high signal, the microprocessor 662 outputs a non-active signal (negated active signal) which is regarded as a logic low signal and provides it to the inverter 82. The inverter 82 negates the non-active signal and outputs an active signal that is regarded as a logic high signal. The active signal (a logic high signal) is provided to the other input terminal of the AND gate 78. Since two logic high signals (V_{BUS}, active signal) are provided to the input terminals of the AND gate 78, respectively, the AND gate 78 outputs a logic high signal. The logic high signal is provided to all of the analog switches 762-776.

The logic high signal allows the analog switches 762 and 764 to connect the USB lines D+1 and D−1 that are connected to the external host 90 to the hub portion 62. The logic high signal also allows the analog switches 766 and 768 to connect the device portion 64 and the hub portion 62. Specifically, the USB hub controller 620 (FIG. 11) of the hub portion 62 is connected to the USB device controller 642 (FIG. 12) of the device portion 64 through the USB lines. In addition, the logic high signal allows the analog switches 770 and 772 to connect the external device 68 (FIG. 7) that is connected to the USB lines D+2 and D−2 to the hub portion 62. Specifically, the USB lines D+2 and D−2 are connected to the USB hub controller 620 (FIG. 11) of the hub portion 62 through the USB lines. Furthermore, the logic high signal allows the analog switches 774 and 776 to connect the external device 70 (FIG. 7) that is connected to the USB lines D+3 and D−3 to the hub portion 62. Specifically, the USB lines D+3 and D−3 are connected to the USB hub controller 620 (FIG. 11) of the hub portion 62 through the USB lines.

In one embodiment of the invention, the mono-stable multi-vibrator 80 may issue a pulse signal based on the logic high signal output from the AND gate 78. The pulse signal allows the reset circuit 74 to issue a reset signal to the hub portion 62 as shown in FIG. 14. The hub portion 62 issues a reset signal to the device portion 64 and the external devices 68 and 70 through the USB lines. Then, the external host 90 becomes ready to communicate with the device portion 64 and the devices 68 and 70 through the hub portion 62. After that, the hub portion 62 of the multiple-role entity 60 allows the external host 90 to perform a host function with respect to the device portion 64 while the external host 90 functions as a host with respect to the external devices 68 and 70 through the hub portion 62.

### Switching Operation from MODE I to Mode II

The external host 90 may be connected to the entity 60 while the host portion 66 of the entity 60 is working as a host (MODE I) with respect to the device portion 64 and at least one of the devices 68 and 70. Then, the comparator 720 of the external host connection detector 72 outputs V_{BUS} to one input terminal of the AND gate 78 and the microprocessor 662 (FIG. 9). While the host portion 66 is communicating with the device portion 64 and at least one of the devices 68 and 70, the host portion 66 may not output a non-active signal even though V_{BUS} (logic high signal) is provided thereto. Instead, the microprocessor 662 of the host portion 66 continues to assert an active signal so that the host portion 66 can complete current data communication with any of the device portion 64 and the devices 68 and 70.

When the host portion 66 completes the current data communication with any of the device portion 64 and the devices 68 and 70, the microprocessor 662 of the host portion 66 negates the active signal and outputs a non-active signal. In this situation, the AND gate 78 outputs a logic high signal as discussed in the operation of MODE II. As a result of that, the analog switches 762 and 764 connect the USB lines D+1 and D−1 that are connected to the external host 90 to the hub portion 62. Also, the analog switches 766 and 768 connect the device portion 64 to the hub portion 62. In addition, the analog switches 770 and 772 connect the external device 68 (FIG. 7) that is connected to the USB lines D+2 and D−2 to the hub portion 62. Furthermore, the analog switches 774 and 776 connect the external device 70 (FIG. 7) that is connected to the USB lines D+3 and D−3 to the hub portion 62.

The mono-stable multi-vibrator 80 may issue a pulse signal based on the logic high signal output from the AND gate 78. The pulse signal is provided to the reset circuit 74 and allows it to issue a reset signal to the hub portion 62. The hub portion 62 issues a reset signal to the device portion 64 and the external devices 68 and 70 through the USB lines. Then, the external host 90 becomes ready to communicate with the device portion 64 and the devices 68 and 70 through the hub portion 62. After that, the hub portion 62 of the multiple-role entity 60 allows the external host 90 to perform a host function with respect to the device portion 64 while the external host 90 still functions as a host with respect to the external devices 68 and 70 through the hub portion 62.

### Switching Operation from MODE II to Mode I

The external host 90 may be disconnected from the entity 60 while the host 90 is working as a host (MODE II) with respect to the device portion 64 and at least one of the devices 68 and 70, or after the host 90 completes its operation. Then, the comparator 720 of the external host connection detector 72 outputs V_{ref} to one input terminal of the AND gate 78 and the microprocessor 662 (FIG. 9). In this situation, the microprocessor 662 of the host portion 66 outputs an active signal. Also, the AND gate 78 outputs a logic high signal as discussed in the operation of MODE I. As a result of that, the analog switches 762 and 764 disconnect the USB lines D+1 and D−1 that are connected to the external host 90 from the hub portion 62. Also, the analog switches 766 and 768 connect the device portion 64 to the host portion 66. In addition, the analog switches 770 and 772 connect the external device 68 (FIG. 7) that is connected to the USB lines D+2 and D−2 to the host portion 66. Furthermore, the analog switches 774 and 776 connect the external device 70 (FIG. 7) that is connected to the USB lines D+3 and D−3 to the host portion 66.

In this situation, the microprocessor 662 of the host portion 66 instructs the USB host controller 660 to issue a USB reset signal in order to start procedures specified in the USB specification on all of the USB lines that are connected between the host portion 66, and the device portion 64 and the external devices 68 and 70. Thus, the device portion 64 and the external devices 68 and 70 become ready to operate with the host portion 66. After that, the host portion 66 of the multiple-role entity 60 performs a host function with respect to at least one of the external devices 68 and 70 while the host portion 66 functions as a host with respect to the device portion 64 in the entity 60.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A system for communicating data with at least one of an external host computer and at least one digital device, the system comprising:
a first entity configured to operate based on received commands; and
a second entity in data communication with the first entity and the at least one digital device, the second entity being configured to perform a hub or host function with respect to a selected one of the first entity and the digital device and, at the same time, to perform the hub or host function with respect to the other of the first entity and the digital device.

2. The system of claim 1, wherein the second entity comprises a host portion configured to perform a host function that provides a host interface with respect to the first entity and the digital device.

3. The system of claim 1, wherein the second entity comprises a hub portion in data communication with the external host computer and configured to perform a hub function that provides a hub interface between the host computer and at least one of the first entity and the digital device.

4. The system of claim 1, wherein the first entity comprises a device portion configured to perform a device function based on received commands.

5. The system of claim 1, wherein the second entity comprises:
a mode selector configured to output first and second mode signals;
a host portion configured to perform a host function that provides a host interface with respect to the first entity and the digital device based on the first mode signal; and
a hub portion in data communication with the external host computer and configured to perform a hub function that provides a hub interface between the host computer and at least one of the first entity and the digital device based on the second mode signal.

6. The system of claim 5, wherein the mode selector comprises an external host connection detector configured to output the first and second mode signals based on detection of whether the external host computer is connected to the system or not.

7. A system for communicating data with at least one of an external host computer and at least one digital device, the system comprising:
a first entity configured to operate based on received commands; and
a second entity in data communication with the first entity and the at least one digital device, the second entity configured to perform a hub or host function with respect to one of the first entity and the digital device during a first time period, and to perform the hub or host function with respect to the other of the first entity and the digital device during a second time period that at least partially overlaps with the first time period.

8. A system for communicating data with at least one of an external host computer and at least one digital device, the system comprising:
a device portion configured to operate based on received commands;
a host portion in data communication with the device portion and the at least one digital device, the host portion being configured to perform a host function that provides a host interface with respect to a selected one of the device portion and the digital device, and at the same time, to perform the host function with respect to the other of the device portion and the digital device; and
a hub portion in data communication with the external host computer, and the device portion and the digital device, the hub portion being configured to perform a hub function that provides a hub interface between the external host and a selected one of the device portion and the digital device, and at the same time to perform the hub function between the external host computer and the other one of the device portion and the digital device.

9. The system of claim 8, further comprising a mode selector configured to output first and second mode signals; and
wherein the host portion is configured to perform the host function based on receiving the first mode signal, and the hub portion is configured to perform the hub function based on receiving the second mode signal.

10. The system of claim 9, further comprising a first switch configured to perform switching between the external host computer and the hub portion, a second switch configured to perform switching between the device portion and one of the hub portion and the host portion, and a third switch configured to perform switching between the at least one digital device and one of the hub portion and the host portion, based on receiving the first and second mode signals.

11. The system of claim 9, wherein the mode selector comprises a host connection detector configured to detect whether the host computer is connected to the system, and to output the first or second mode signals based on the result of the detection.

12. The system of claim 8, wherein the external host computer and the device are connected to the system by USB lines.

13. The system of claim 8, wherein the system comprises a digital camera.

14. A system for communicating data with at least one of an external host computer and at least one digital device, the system comprising:
a device portion configured to operate based on received commands;
a host portion in data communication with the device portion and the at least one digital device, the host portion configured to perform a host function that provides a host interface with respect to one of the device portion and the digital device during a first time period, and to perform the host function with respect to the other of the device portion and the digital device during a second time period that at least partially overlaps with the first time period; and
a hub portion in data communication with the external host computer, and the device portion and the digital device, the hub portion configured to perform a hub function that provides a hub interface between the external host computer and a selected one of the device portion and the digital device in a third time period, and to perform the hub function between the external host computer and the other one of the device function and the digital device during a fourth time period that at least partially overlaps with the third time period.

15. A system for communicating data with at least one of an external host computer and at least one digital device, the system comprising:
a device portion configured to operate based on received commands; and
a host portion in data communication with the device portion and the at least one digital device, the host portion configured to perform a host function that provides a host interface with respect to one of the device portion and the digital device, and at the same time, to perform the host function with respect to the other of the device portion and the digital device.

16. A system for communicating data with at least one of an external host computer and at least one digital device, the system comprising:
a device portion configured to operate based on received commands; and
a hub portion in data communication with the external host computer, and the device portion and the digital device, the hub portion configured to perform a hub function that provides a hub interface between the external host computer and one of the device portion and the digital device, and at the same time, to perform the hub function between the external host computer and the other one of the device portion and the digital device.

17. A method of communicating data in a system having at least one of an external host computer and at least one digital device, the method comprising:
providing a first entity and a second entity, the first entity configured to operate based on received commands;
connecting the second entity to the first entity and the at least one digital device; and
allowing the second entity to perform a host or hub function with respect to one of the first entity and the digital device while the second entity performs the host or hub function with respect to the other of the first entity and the digital device.

18. The method of claim 17, further comprising generating a mode signal based on detection of whether the external host computer is connected to the system or not, wherein the allowing comprises allowing the second entity to perform the host function that provides a host interface with respect to the first entity and the digital device.

19. The method of claim 17, further comprising generating a mode signal based on detection of whether the external host computer is connected to the system or not, wherein the allowing comprises allowing the second entity to perform the hub function that provides a hub interface between the external host computer and at least one of the first entity and the digital device.

20. A method of communicating data in a system having a multiple-role entity, and at least one of a host computer and a digital device, the method comprising:
communicating data between a device portion and another functional portion within the multiple-role entity;
communicating data between the other functional portion and an external interface; and
selecting the other functional portion to communicate with the digital device or the host computer via the external interface.

21. The method of claim 20, further comprising, if allowing communication with the host computer, also allowing communication between the host computer and the digital device via the other functional portion.

22. The method of claim 20, wherein the external interface is a host interface.

23. A method of communicating data in a system having at least one of a host computer and a digital device, the method comprising:
providing a device portion, a host portion and a hub portion, the device portion being configured to operate based on received commands, the host portion being configured to perform a host function that provides a host interface, and the hub portion being configured to perform a hub function that provides a hub interface;
allowing the host portion to perform the host function with respect to one of the device portion and the digital device while the host portion performs the host function with respect to the other of the device portion and the digital device; and
allowing the hub portion to perform the hub function between the host computer and one of the device portion and the digital device while the hub portion performs the hub function the external host computer and the other of the device portion and the digital device.

24. The method of claim 23, further comprising generating first and second mode signals based on detection of whether the host computer is connected to the system or not, wherein the allowing the host portion comprises allowing the host portion to perform the host function based on receiving the first mode signal, and wherein the allowing the hub portion comprises allowing the hub portion to perform the hub function based on receiving the second mode signal.

25. A method of communicating data in a system having at least one of a host computer and a digital device, the method comprising:
providing a device portion and a host portion in the system, the device portion being configured to operate based on received commands, and the host portion being configured to perform a host function that provides a host interface;
connecting the host portion to the device portion and the digital device; and
allowing the host portion to perform the host function with respect to one of the device portion and the digital device while the host portion performs the host function with respect to the other of the device portion and the digital device.

26. The method of claim 25, further comprising
providing a hub portion in the system, the hub portion being configured to perform a hub function that provides a hub interface;
detecting whether the external host computer is connected to the system;
if the host computer is connected to the system, disconnecting the host portion from the device portion and the digital device;
connecting the host computer to the device portion and the digital device through the hub portion; and
allowing the hub portion to perform the hub function between the host computer and one of the device portion and the digital device while the hub portion performs the hub function between the external host computer and the other of the device portion and the digital device.

27. A method of communicating data in a system having at least one of a host computer and a digital device, the method comprising:
providing a device portion and a hub portion in the system, the device portion being configured to operate based on received commands, and the hub portion being configured to perform a hub function that includes a hub interface;
connecting the host computer to the device portion and the digital device through the hub portion; and
allowing the hub portion to perform the hub function between the host computer and one of the device portion and the digital device while the hub portion performs the hub function between the external host computer and the other of the device portion and the digital device.

28. The method of claim 27, further comprising
providing a host portion in the system, the host portion being configured to perform a host function that provides a host interface;
detecting whether the host computer is disconnected from the system;
if the host computer is disconnected from the system, connecting the host portion to the device portion and the digital device; and
allowing the host portion to perform the host function with respect to one of the device portion and the digital device while the host portion performs the host function with respect to the other of the device portion and the digital device.

29. A method of communicating data in a system having at least one of a host computer and a digital device, the method comprising:
providing a device portion, a host portion and a hub portion, the device portion being configured to operate based on received commands, the host portion being configured to perform a host function that provides a host interface, and the hub portion being configured to perform a hub function that provides a hub interface;
generating first and second mode signals;
allowing the host portion to perform the host function with respect to one of the device portion and the digital device while the host portion performs the host function with respect to the other of the device portion and the digital device based on the first mode signal; and
allowing the hub portion to perform the hub function between the host computer and one of the device portion and the digital device while the hub portion performs the hub function between the host computer and the other of the device portion and the digital device based on the second mode signal.

30. A method of communicating data in a system having at least one of a host computer and a digital device, the method comprising:
providing a first entity and a second entity, the first entity being configured to operate based on received commands;
connecting the second entity to the first entity and the digital device;
allowing the second entity to perform a host or hub function with respect to one of the first entity and the digital device in a first time period; and
allowing the second entity to perform the host or hub function with respect to the other of the first entity and the digital device in a second time period that at least partially overlaps with the first time period.

31. A method of communicating data in a system having at least one of a host computer and at least one digital device, the method comprising:
providing a first entity and a second entity, the first entity being configured to operate based on received commands;
connecting the second entity to the first entity and the a digital device; and
allowing the second entity to perform a host or hub function with respect to one of the first entity and the digital device and at the same time to perform the host or hub function with respect to the other of the first entity and the digital device.

32. The method of claim 31, wherein the digital device comprises more then one digital device.
